(19) United States
(12) Patent Application Publication
(10) Pub. No.: US 2004/0209990 A1
(43) Pub. Date: Oct. 21, 2004

(54) Low shrinking polymerizable dental material

(76) Inventors: Uwe Walz, Konstanz (DE); Joachim E. Klee, Radolfzell (DE)

Correspondence Address: Douglas J. Hura, Esquire, DENTSPLY International Inc., 570 West College Avenue, York, PA, 17405-0872, US

(21) Appl. No.: 10/755,543

(22) Filed: Jan. 12, 2004

Related U.S. Application Data
(63) Continuation-in-part of application No. 10/413,753, filed on Apr. 15, 2003, now abandoned.

(51) Int. Cl. C08L 31/00

(52) U.S. Cl. 524/533; 524/559; 524/590

(57) ABSTRACT

A low shrinking polymerizable dental material, includes a mixture of a polymerizable di- or poly(meth)acrylate, an alkoxylated bisphenol dimethacrylate, a polymerizable monomer, a polymerization initiator and/or sensitizer, a stabilizer and a filler in a content of 70 to 85 percent. The volumetric shrinkage during polymerization is less than 2.0 vol.-%.

### TECHNICAL BACKGROUND

Dental filling materials often consist of polymerizable organic monomers and/or polymers, polymerizable monomers, polymerization initiators, and fillers. Known commercial dental composites exhibit useful mechanical properties, such as compressive strengths ranging from 300 to 500 MPa and flexural strengths ranging from 130 to 170 MPa. Furthermore, over the past years they have been improved with respect to abrasion resistance, marginal integrity, fatigue behavior and their optical properties. Nevertheless, a volumetric shrinkage of 2.5 to 4.0% often takes place during the polymerization of these composites. This may cause microfractures in the material and sometimes enamel edge cracks. Frequently, secondary caries are formed as result of these defects. Therefore, it is desirable to provide new composite materials that exhibit reduced volumetric shrinkage without sacrificing other useful properties

It is known to use 2,2-Bis-[p-(2-hydroxy-3-methacryloyloxypropoxy)-phenyl]-propane (Bis-GMA) as a monomer for dental materials due to its advantageous properties. However, it shows a relatively high viscosity that makes the application of low viscous monomers necessary. It is known that the shrinkage directly depends on the molecular weight of polymerizable organic monomers. On the other hand, increasing molecular weights of the monomers results in an increasing viscosity of the resin. Therefore, polymerizable monomers, such as oligoethyleneglycol dimethacrylates, are used to obtain a lower viscosity and allows the incorporation of desired amounts of fillers. However, polymerizable monomers show a relatively high shrinkage by themselves, for example 12.89 vol.-% for pure triethyleneglycol dimethacrylate. This leads to a high crosslinking density and brittleness.

Alkoxylated Bis-GMA's were used as relatively low viscous monomers in content of 15 to 30% and applied in redox-polymerizable paste-paste composites. Frequently, in combination with other polymerizable monomers ethoxylated or propoxylated Bis-GMA was applied to improve mechanical properties, water sorption and wear resistance. Recently, composites were used that comprise Urethane dimethacrylates, Triethyleneglycol dimethacrylate 2,2-Bis-[p-(2-hydroxy-3-methacryloyl-oxypropoxy)-phenyl]-propane, and the so called BisEMA6. Another is an ethoxylated Bis-GMA having 6 to 8 ethoxy moieties and it is used in contents of 15 to 45%. All percents or “%” are by weight (w/w) unless otherwise noted.

Reaction products of diisocyanates and glycerol di(meth)acrylate have been used to prepare a cement composition. Furthermore, compounds have been prepared form vinyl urethane condensate (oxypropylated bisphenol-A), hexamethylene diisocyanate and hydroxypropyl methacrylate.

In U.S. Pat. No. 4,089,763 a method of repairing teeth was described by using a composition comprising particles with a maximum dimension not greater than 500 μm (micrometers or “microns”) and a polymerizable prepolymer containing at least two polymerizable ethylenically unsaturated groups being the reaction product of a urethane prepolymer and a polymerizable ethylenically unsaturated monomer.

Special monomers such as tricyclodecane derivatives, polyols, urethane dimethacrylates of diisocyanates and hydroxyalkylmethacrylates show a relatively low volumetric shrinkage which give reason to suppose that the use of monomers with a higher molecular weight would be successful in the application for dental composites.

### DISCLOSURE OF THE INVENTION

It is therefore, an object of the invention, to provide a low shrinking, polymerizable dental material.

It is another object of the invention to provide such a material useful as a dental restorative material.

These and other objects of the invention, which shall become apparent from the following description, are achieved by the invention as hereinafter described and claimed.

In general, a low shrinking polymerizable dental material, comprises a mixture of

(i) 70 to 85 w/w of an organic or an inorganic filler and

(ii) 15 to 30% w/w of a polymerizable resin matrix having a volumetric polymerization shrinkage of less than 2% v/v (by volume). In an alternative embodiment, the material may be a mixture of

(a) 25 to 40% w/w of a polymerizable di- or poly(meth)acrylate,

(b) 45 to 65% w/w of an alkoxylated bisphenol dimethacrylate,

(c) 0 to 20% w/w of a polymerizable monomer,

(d) 0.1 to 3.0% w/w of polymerization initiator and/or sensitizer and stabilizer and

(e) 0 to 10% w/w of an antimicrobial compound.

In a further embodiment, the alkoxylated bisphenol dimethacrylate can be characterized by the following formula

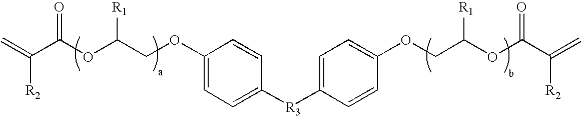

wherein R₁ and R₂ independently denote H (hydrogen) or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene

R₃ is a difunctional substituted or unsubstituted C₁ to C₁₈ alkyl, O, S, SO₂ or C(CF₃)₂,

a and b are integers wherein a+b is from about 2 to about 20.

The alkoxylated bisphenol dimethacrylate may alternatively be characterized by the following formula

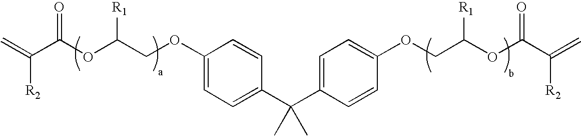

wherein R₁ and R₂ independently denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene a and b are integers wherein a+b is between about 2 and about 20.

In a still further embodiment, the polymerizable di- or poly(meth)acrylate is the reaction product of molecules A and B with C

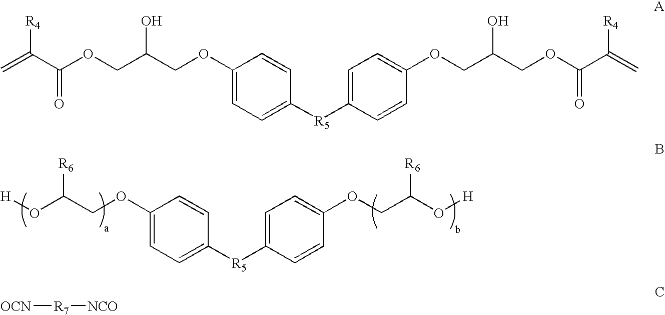

whereby the molar ratio of A and B varies between 1.0 to 0 and 0.2 to 0.8 and the molar ratio of (A+B) and C varies between 1.0 to 0.05 and 1.0 to 1.1, wherein R₄ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene; R₅ is a difunctional substituted or unsubstituted C₁ to C₁₈ alkyl, O, S, SO₂ or C(CF₃)₂, R₆ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene R₇ is a difunctional substituted or unsubstituted C₂ to C₃₀ alkylene, C₅ to C₃₀ substituted or unsubstituted cycloalkylene, substituted or unsubstituted C₅ to C₃₀ arylene or heteroarylene a and b are integers.

In a further embodiment, the polymerizable di- or poly(meth)acrylate is formed from the reaction product of molecules A and B with C

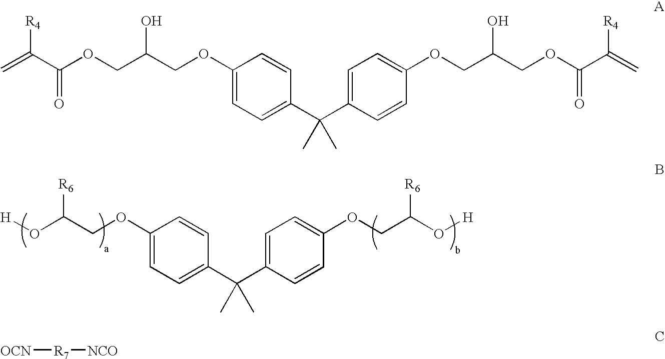

whereby the molar ratio of A and B varies between 1.0 to 0 and 0.2 to 0.8 and the molar ratio of (A+B) and C varies between 1.0 to 0.05 and 1.0 to 1.1,

wherein R₄ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene R₆ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene R₇ is a difunctional substituted or unsubstituted C₂ to C₃₀ alkylene, C₅ to C₃₀ substituted or unsubstituted cycloalkylene, substituted or unsubstituted C₅ to C₃₀ arylene or heteroarylene; and, a and b are integers as hereinabove.

The polymerizable monomer is a mono- or polyfunctional acrylate or methacrylate, such as diethyleneglycol dimethacrylate, triethyleneglycol dimethacrylate, 3,(4),8,(9)-dimethacryloyloxymethyltricyclodecane, dioxolane bismethacrylate, vinyl-, vinylene- or vinylidene-, acrylic- or methacrylic substituted spiroorthoesters, spiroorthocarbonates or bicycloorthoesters, glycerin trimethacrylate, trimethylolpropane triacrylate, furfurylmethacrylate.

### DESCRIPTION OF THE INVENTION

It has surprisingly been found that a low shrinking polymerizable dental material having a volumetric polymerization shrinkage of less than 2% v/v is obtainable comprising a mixture of

(i) 70 to 85 w/w of an organic or an inorganic filler and

(ii) 15 to 30% w/w of a polymerizable resin matrix.

The polymerizable resin matrix comprises a mixture of, for example,

(i) 25 to 40% w/w of a polymerizable di- or poly(meth)acrylate,

(ii) 45 to 65% w/w of an alkoxylated bisphenol dimethacrylate,

(iii) 0 to 20% w/w of a polymerizable monomer and

(iv) 0.1 to 3.0% w/w of polymerization initiator and/or sensitizer and stabilizer.

The alkoxylated bisphenol dimethacrylate may be characterized by the following formula

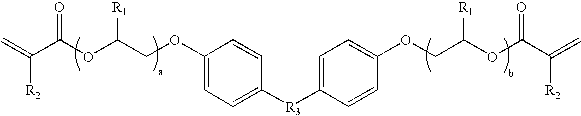

wherein R₁ and R₂ independently denote H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene;

R₃ is a difunctional substituted or unsubstituted C₁ to C₁₈ alkyl, O, S, SO₂ or C(CF₃)₂; and, a and b are integers. Preferably a+b is between 2 and 20, more preferably a+b is between 8 and 20.

Preferably the alkoxylated bisphenol dimethacrylate is characterized by the following formula

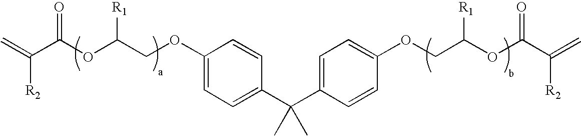

wherein R₁ and R₂ independently denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene, and a and b are integers.

An example of a useful polymerizable di- or poly(meth)acrylate is the reaction product of molecules A and B with diisocyanate C as follows:

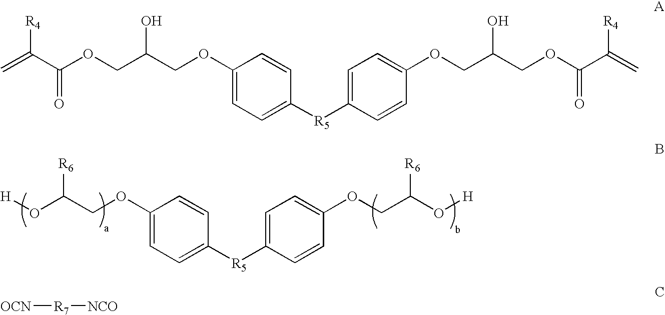

wherein the molar ratio of A and B varies between 1.0 to 0 and 0.2 to 0.8 and the molar ratio of (A+B) and C varies between 1.0 to 0.05 and 1.0 to 1.1; wherein R₄ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene; R₅ is a difunctional substituted or unsubstituted C₁ to C₁₈ alkyl, O, S, SO₂ or C(CF₃)₂; R₆ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene; R₇ is a difunctional substituted or unsubstituted C₂ to C₃₀ alkylene, C₅ to C₃₀ substituted or unsubstituted cycloalkylene, substituted or unsubstituted C₅ to C₃₀ arylene or heteroarylene and a and b are integers as hereinabove.

In the alternative, the polymerizable di- or poly(meth)acrylate is received by reaction of molecules A and B with diisocyanate C

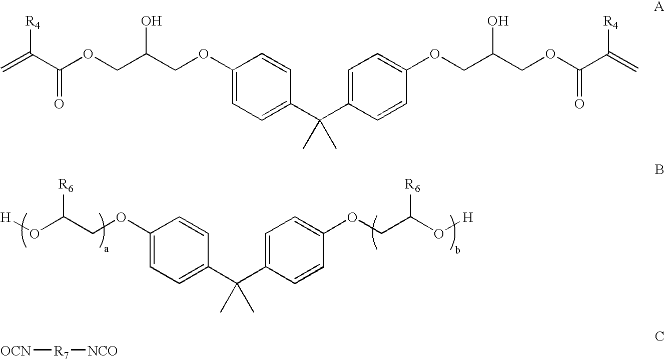

whereby the molar ratio of A and B varies between 1.0 to 0 and 0.2 to 0.8 and the molar ratio of (A+B) and C varies between 1.0 to 0.05 and 1.0 to 1.1; wherein R₄ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene; R₆ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene; R₇ is a difunctional substituted or unsubstituted C₂ to C₃₀ alkylene, C₅ to C₃₀ substituted or unsubstituted cycloalkylene, substituted or unsubstituted C₅ to C₃₀ arylene or heteroarylene; and a and b are integers as hereinabove.

As polymerizable monomers are usable mono- and polyfunctional acrylates or methacrylates, such as diethyleneglycol dimethacrylate, triethyleneglycol dimethacrylate, 3,(4),8,(9)-dimethacryloyloxymethyl tricyclodecane, dioxolane bismethacrylate, vinyl-, vinylene- or vinylidene-, acrylic- or methacrylic substituted spiroorthoesters, spiroorthocarbonates or bicycloorthoesters, glycerin trimethacrylate, trimethylolpropane triacrylate, furfurylmethacrylate.

The photoinitiator is for example benzoinmethylether, benzilketal, camphor quinone/amine, or an acylphosphinoxide in a content of 0.1 to 3 wt-%, or any other conventional and useful photoinitiator.

The low shrinking dental material is filled with inorganic fillers, inorganic compounds such as La₂O₃, ZrO₂, BiPO₄, CaWO₄, BaWO₄, SrF₂, Bi₂O₃, porous glasses or organic fillers, such as polymer granulate or a combination of organic and/or inorganic fillers or reactive inorganic fillers having a average diameter of less than about 10 μm.

The volumetric shrinkage was measured using AccuPyc 1300 (Micrometrics, USA) based on measurements of density of polymerized and non-polymerized composite followed by calculation of volumetric shrinkage. This method was applied and described by W. D. Cook et al., Dent. Mat. 15 (1999) 447.

The Archimedes method for estimation of the shrinkage bases on the measurement of the weight of the non-polymerized and of the polymerized material on air and in water. From these values the densities are calculated. The densities of the non-polymerized and of the polymerized material are used for calculating the shrinkage.

### EXAMPLE 1

27.864 g 2,2-Bis-[p-(2-hydroxy-3-methacryloyloxypropoxy)-phenyl]-propane, 61.308 g Ethoxylated Bis-GMA CD540, 2.500 g Diethylene glycol dimethacrylate and 0.330 g Dibutyl tinlaurate were mixed homogeneously under stirring and heating at 40° C. To this reaction mixture 7.898 g Hexamethylene diisocyanate were added and reacted until the absorption band of isocyanate completely disappeared at 2220 cm⁻¹.

Thereafter 0.1 g 2,6-di-tert.-butyl-4-cresol, 0.300 g camphor quinone and 0.350 g Dimethyl aminobenzoic acid ethylester were dissolved in the polymerizable matrix resin. This resin has a viscosity at 23° C. of 57.3±0.8 Pa*s and a refractive index at 20° C. of 1.5360.

Using 24.350 g polymerizable matrix resin and 75.650 g Barium alumo silicate glass a composite was prepared by mixing and stirring under vacuum.

The properties of the composite are summarized in Tale 1.

### EXAMPLE 2

20.898 g 2,2-Bis-[p-(2-hydroxy-3-methacryloyloxypropoxy)-phenyl]-propane, 63.395 g Ethoxylated Bis-GMA (CD540 Sartomer), 4.681 g Bisphenol-A-propoxylat (1PO/Phenol), 2.500 g Diethylene glycol dimethacrylate and 0.330 Dibutyl tinlaurate were mixed homogeneously under stirring and heating at 40° C. To this reaction mixture 7.898 g Hexamethylene diisocyanate were added and reacted until the absorption band of isocyanate completely disappeared at 2220 cm⁻¹.

Thereafter 0.1 g 2,6-di-tert.-butyl-4-cresol, 0.300 g camphor quinone and 0.350 g Dimethyl aminobenzoic acid ethylester were dissolved in the polymerizable matrix resin. This resin has a viscosity at 23° C. of 48.6±0.2 Pa*s, a refractive index at 20° C. of 1.5361 and a volumetric shrinkage dV (A)=4.15%.

Using 24.560 g polymerizable matrix resin and 75.440 g Barium alumo silicate glass a composite was prepared by mixing and stirring under vacuum.

The properties of the composite are summarized in Table 1.

### COMPARATIVE EXAMPLES 1-10

In the following are summarized the results of shrinkage measurement using AccuPyc 1330 of commercial composites as well as their mechanical properties.

TABLE 1
Properties of claimed and competitive composites

| | | | | Polymerization | Compressive | Flexural | |
|---|---|---|---|---|---|---|---|
| | | | | ΔV*) | strength | strength | E-modules |
| Composite | Producer | Batch | Color | % | MPa | MPa | MPa |
| Example 1 | Dentsply | MG3-148-1 | non-colored | 1.854 ± 0.046 | 342 ± 14 | 119 ± 14 | 8000 ± 592 |
| Example 2 | Dentsply | MG3-159-3 | non-colored | 1.501 ± 0.102 | 307 ± 18 | 133 ± 10 | 7574 ± 748 |
| Synergy | Coltene | IB741 | A2 | 2.683 ± 0.105 | 343 ± 19 | 114 ± 4 | 7590 ± 280 |
| Spectrum | Dentsply | 00591 | A2 | 3.156 ± 0.105 | 325 ± 21 | 101 ± 5 | 8174 ± 292 |
| Z100 | 3M | 19980130 | A2 | 2.305 ± 0.125 | 403 ± 23 | 135 ± 4 | 12219 ± 554 |
| Herculite | Kerr | 904125 | C2 | 2.475 ± 0.096 | 337 ± 30 | 110 ± 7 | 7790 ± 328 |
| Prodigy | Kerr | 906417 | A2 | — | 352 ± 34 | 120 ± 10 | 6880 ± 194 |
| Prodigy cond. | Kerr | 910154 | A2 | 2.759 ± 0.020 | 355 ± 19 | 96 ± 8 | 7159 ± 421 |
| Solitaire | Kulzer | 29 | A20 | 3.096 ± 0.114 | 382 ± 20 | 56 ± 6 | 3789 ± 363 |
| Charisma | Kulzer | 60026 | A2 | 3.253 ± 0.129 | 3565 ± 16 | 98 ± 14 | 7491 ± 274 |
| Tetric Ceram | Vivadent | B10473 | A2 | 2.491 ± 0.048 | 343 ± 21 | 125 ± 4 | 8822 ± 280 |
| Ariston pHc | Vivadent | B21134 | universal | 2.539 ± 0.180 | 309 ± 12 | 97 ± 8 | 8076 ± 512 |
| | | | white | | | | |

*)Measurement of density of polymerized and non-polymerized composite using AccuPyc 1330 followed by calculation of volumetric shrinkage

It should now be apparent that a dental material according to the foregoing description accomplishes the objects of the invention and otherwise makes a contribution to the art. The foregoing description illustrates preferred embodiments of the invention. However, concepts employed may, based upon the description, be employed in other embodiments without departing from the scope of the invention.

We claim:

1. A low shrinking polymerizable dental material, comprises a mixture of
(a) 70 to 85% w/w of an organic or an inorganic filler and
(b) 15 to 30% w/w of a polymerizable resin matrix, and has a volumetric polymerization shrinkage of less than 2 percent by volume; wherein the material comprises a mixture of
(c) 25 to 40% w/w of a polymerizable di- or poly(meth)acrylate,
(d) 45 to 65% w/w of an alkoxylated bisphenol dimethacrylate,
(e) 0 to 20% w/w of a polymerizable monomer,
(f) 0.1 to 3.0% w/w of polymerization initiator and/or sensitizer and stabilizer and
(g) 0 to 10% w/w of an antimicrobial compound; said alkoxylated bisphenol dimethacrylate is selected from the group consisting of 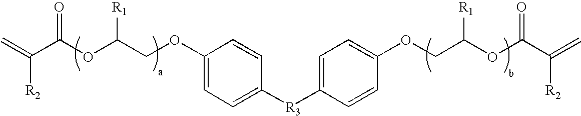
wherein R₁ and R₂ independently denote H (hydrogen) or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene, R₃ is a difunctional substituted or unsubstituted C₁ to C₁₈ alkyl, O, S, SO₂ or C(CF₃)₂,
a and b are integers wherein a +b is from about 2 to about 20, and, 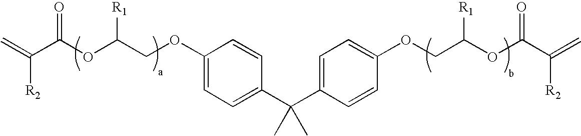
wherein R₁ and R₂ independently denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene, and a and b are integers wherein a+b is between about 2 and about 20;
and wherein said polymerizable di- or poly(meth)acrylate is selected from the group consisting of the reaction product of molecules A and B with C 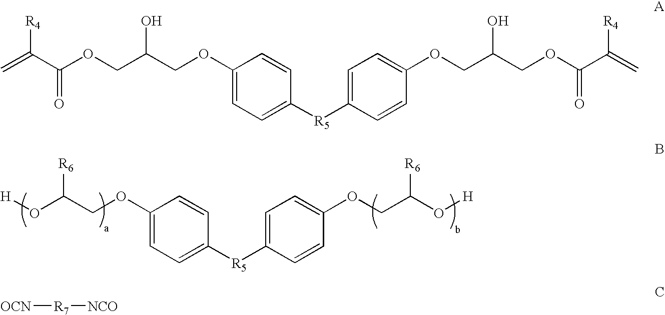
whereby the molar ratio of A and B varies between 1.0 to 0 and 0.2 to 0.8 and the molar ratio of (A+B) and C varies between 1.0 to 0.05 and 1.0 to 1.1, wherein R₄ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene; R₅ is a difunctional substituted or unsubstituted C₁ to C₁₈ alkyl, O, S, SO₂ or C(CF₃)₂, R₆ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene R₇ is a difunctional substituted or unsubstituted C₂ to C₃₀ alkylene, C₅ to C₃₀ substituted or unsubstituted cycloalkylene, substituted or unsubstituted C₅ to C₃₀ arylene or heteroarylene a and b are integers, and the reaction product of molecules D and E with F 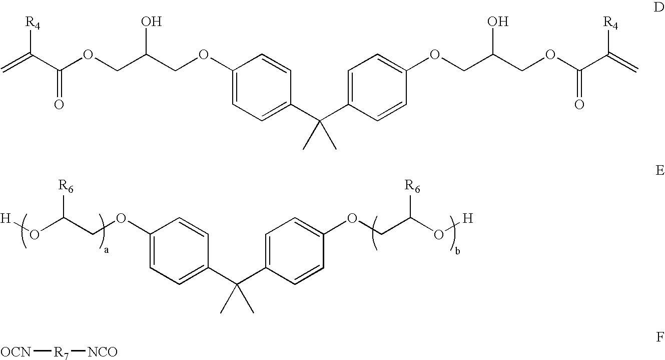
whereby the molar ratio of D and E varies between about 1.0 to 0 and about 0.2 to about 0.8 and the molar ratio of (D+E) and F varies between about 1.0 to about 0.05 and about 1.0 to about 1.1; wherein R₄ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene R₆ denotes H or a monofunctional substituted or unsubstituted C₁ to C₁₈ alkyl, C₅ to C₁₈ substituted or unsubstituted cycloalkyl, substituted unsubstituted C₅ to C₃₀ arylene or heteroarylene R₇ is a difunctional substituted or unsubstituted C₂ to C₃₀ alkylene, C₅ to C₃₀ substituted or unsubstituted cycloalkylene, substituted or unsubstituted C₅ to C₃₀ arylene or heteroarylene and a and b are integers as above;
and wherein said polymerizable monomer is selected from the group consisting of mono- and polyfunctional acrylate and methacrylateacrylate.
